(19) United States
(12) Patent Application Publication
(10) Pub. No.: US 2004/0227778 A1
(43) Pub. Date: Nov. 18, 2004

(54) METHOD FOR REDUCING POWER CONSUMPTION OF MULTIMEDIA DATA PLAYBACK ON A COMPUTER SYSTEM

(76) Inventors: Wen-Cheng Lin, Taipei Hsien (TW); Shih-Chou Yang, Kao-Hsiung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,853

(22) Filed: May 13, 2003

(51) Int. Cl. G09G 5/00

(52) U.S. Cl. 345/719; 715/500.1

(57) ABSTRACT

A method for playing multimedia data on a computer system. The computer system has a central processing unit (CPU) used to control operations of the computer system, a storage device used to retrieve the multimedia data, a bridge circuit electrically connected between the CPU and the storage device for coordinating data transmission between the CPU and the storage device, and an output device. The method includes providing the computer system with a playback controller electrically connected to the storage device and the output device, controlling the storage device to transmit the multimedia data to the playback controller without activating the bridge circuit, utilizing the playback controller to receive and process the multimedia data, and utilizing the playback controller to drive the output device to play the multimedia data.

### BACKGROUND OF INVENTION

1. Field of the Invention

The present invention relates to a multimedia playback method of a computer system for playing multimedia data. In particular, the present invention discloses a multimedia playback method of a computer system that is capable of reducing power consumption associated with the computer system.

2. Description of the Prior Art

In this information society, computer systems widely used in every industry are playing an important role in many companies. With improvements such as an increasing data storage density, a rising operation speed, a decreasing production cost, and a friendlier user interface, a computer system such as a personal computer (PC) can act as an information-processing center. Nowadays, multimedia technology is used to provide users with exciting amusements. For example, films are recorded on optical disks such as digital versatile discs (DVDs) or video compact disks (VCDs). Therefore, if an optical disk drive is installed on the personal computer, data associated with a specific film are capable of being retrieved, and then the retrieved data are played by the personal computer. Please refer to FIG. 1, which is a block diagram of a prior art computer system 10. The computer system 10 comprises a central processing unit (CPU) 12, a north bridge circuit 14, a south bridge circuit 16, a memory 18, an optical disk drive 20, a display system 22, and a monitor. The display system 22 includes a display controller 28 and a video transmitter 30. The CPU 12 is used to control operation of the computer system 10. The north bridge circuit 14 is electrically connected to the CPU 12, and is used to control signals transmitted between the CPU 12 and high-speed devices such as the memory 18 and the display controller 28. The south bridge circuit 16 is electrically connected to the north bridge circuit 14, and is used to control signals transmitted between the north bridge circuit 14 and the low-speed devices such as the optical disk drive 20 and the input device 24. The memory 18 such as a dynamic random access memory (DRAM) is used to store data. The optical disk drive 20 is used to retrieve data stored on an optical disk. The input device 24 is used to receive commands issues by a user. For instance, the input device 24 may be a keyboard for transmitting character signals or a mouse for transmitting pointing signals. The display system 22 is used to drive the monitor 26 to display images. The display controller 24 is capable of performing 2D and 3D graphics calculation, and outputs corresponding image signals to the video transmitter 30. The transmitter 30 is capable of converting the image signals into driving signals that are suitable for the monitor 26. For example, if the monitor 26 is a liquid crystal display (LCD) monitor, the transmitter 30 converts the image signals into driving signals compatible with digital visual interface (DVI) specification.

The optical disk drive 20 is powered on after the computer system 10 is powered on and a boot procedure such as a power-on-self-test (POST) is started. After an operating system is loaded, the user can use the optical disk drive 20 to retrieve data stored on the optical disk. For example, the user uses the input device 24 to command the CPU 12 to execute a playback application. Then, the playback application commands the optical disk drive 20 to retrieve data stored on the optical disk such a DVD or a VCD. The optical disk drive 20 passes the retrieved data to the playback application executed by the CPU 12 through the south bridge circuit 16 and the north bridge 14. The playback application first commands the display controller 28 to decode the retrieved data for generating image signals, and then the image signals are transmitted to the video transmitter 30 for successfully driving the monitor 26. In the end, the user can see the film associated with the data stored on the optical disk through the monitor 26.

As mentioned above, in order to play the data stored on the optical disk, the computer system 10 needs to be powered on first. However, the components within the computer system 10 dissipate a great amount of power. Taking a laptop computer for example, the required power is primarily provided by a battery device. With regard to a Pentium® 4 system, the overall power consumption is greater than 100 watts. However, not every powered circuit is necessary for playing the data stored on the optical disk drive. For example, a hard-disk drive is not used, but the hard-disk drive still consumes power to spin the magnetic disk. It is obvious that thermal management becomes a serious problem when the computer system 10 has great power consumption and according power dissipation. In addition, the electric power provided by the battery device is not durable under this situation. Therefore, it is not convenient for the user to use the computer system 10 such as the laptop computer to play video data stored on the DVD or the VCD.

### SUMMARY OF INVENTION

It is therefore a primary objective of this invention to provide a method for reducing power consumption of a computer system when multimedia data are played on the computer system.

Briefly summarized, the preferred embodiment of the claimed invention discloses a method for playing multimedia data on a computer system. The computer system comprises a central processing unit (CPU) used to control operations of the computer system, a storage device used to retrieve the multimedia data, a bridge circuit electrically connected between the CPU and the storage device for coordinating data transmission between the CPU and the storage device, and an output device. The method comprises providing the computer system with a playback controller electrically connected to the storage device and the output device, controlling the storage device to transmit the multimedia data to the playback controller without activating the bridge circuit to process the multimedia data, and utilizing the playback controller to process the multimedia data and drive the output device to play the multimedia data.

It is an advantage of the claimed invention that the playback controller can work even if the computer system is not booted up. Therefore, the power consumption associated with playback of multimedia data is greatly reduced because only part of the components within the computer system dissipate power. In addition, because the user does not need to completely boot up the claimed computer system for playing multimedia data, it is convenient and simple for the user to operate the claimed computer system to play multimedia playback without waiting for the lengthy booting procedure. In addition, power consumption of the computer system is reduced without booting up the computer system. If the computer system is booted up, the playback controller can directly process multimedia data without help of the south bridge circuit, the central processing unit, etc. Therefore, power consumption of the computer system is reduced as well.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a prior art computer system.

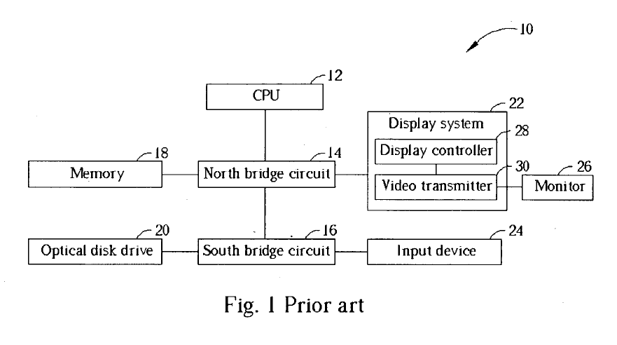

FIG. 2 is a block diagram of a computer system according to the present invention.

### DETAILED DESCRIPTION

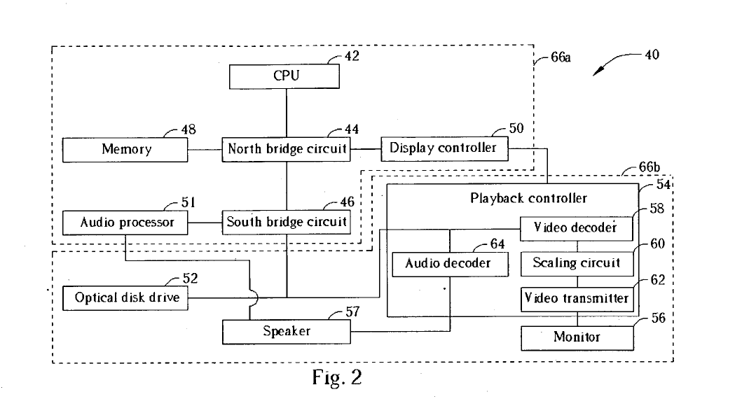

Please refer to FIG. 2, which is a block diagram of a computer system 40 according to the present invention. The computer system 40 has a central processing unit (CPU) 42, a north bridge circuit 44, a south bridge circuit 46, a memory 48, a display controller 50, an audio processor 51, an optical disk drive 52, a playback controller 54, a monitor 56, and a speaker 57. The playback controller 54 includes a video decoder 58, a scaling circuit 60, a video transmitter 62, and an audio decoder 64.

The CPU 42 is used to control operation of the computer system 40. The north bridge circuit 44 is used to control signals transmitted between the CPU 42 and the high-speed devices such as the memory 48 and the display controller 50. The south bridge circuit 46 is used to control signals transmitted between the north bridge circuit 44 and the optical disk drive 52. The memory 48 is used to store data. For example, the memory 48 can be either a volatile memory such as a dynamic random access memory (DRAM) or a non-volatile memory such as a flash memory. The display controller 50 is used to perform 2D and 3D graphics calculations, and then generates image signals for driving the monitor 56 to display images corresponding to the image signals. The audio processor 51 is used to convert digital audio data into corresponding digital audio signals. For instance, the audio processor 51 is a well-known sound chip disposed on an add-on soundcard or on a motherboard of the computer system 40. The optical disk drive 52 is used to retrieve data stored on an optical disk. For instance, the optical disk is a digital versatile disk (DVD), and the optical disk drive 52 is a DVD drive. If the optical disk is a video compact disk (VCD) or an audio compact disk, the optical disk drive 52 is a CD drive. The playback controller 54 is connected to the optical disk drive 52 and the display controller 50.

Operation of the computer system 40 is described as follows. The components of the computer system 40 are divided into two power blocks 66a, 66b. As shown in FIG. 2, the power block 66a includes the CPU 42, the north bridge circuit 44, the south bridge circuit 46, the memory 48, and the display controller 50. The power block 66b includes the optical disk drive 52, the playback controller 54, the monitor 56, and the speaker 57. Suppose that the whole computer system 40 is a laptop computer, and is originally powered off. If a user wants to see a film stored on a DVD or a VCD, only the power block 66b is actuated. The power block 66a is kept disabled. For example, if the user presses a button such as an “OPEN” button or a “PLAY” button located at housing of the optical disk drive 52, the power block 66b is then selected. Therefore, a battery device provides devices belonging to the power block 66b with required operating voltages. The optical disk drive 52 then is capable of accessing the optical disk loaded into the optical disk drive 52. The video data stored on the optical disk are transmitted to the playback controller 54. It is well-known that the video data are encoded according to a predetermined algorithm such as a MPEG-2 standard. The video decoder 58 is capable of decoding the received encoded video data, and outputs the decoded video data to the scaling circuit 60. The scaling circuit 60 is used to adjust the decoded video data to meet a display resolution supported by the monitor 56. For example, the video data corresponds to a 640×408 resolution. That is, 640*480 pixels are required to reproduce each frame associated with the film. However, if the monitor 56 supports a resolution 1280×1024, the scaling circuit 60 is capable of adjusting the video data so that the video data originally supporting the 640×408 resolution can be displayed on the monitor 56 supporting the resolution 1280×1024. On the contrary, suppose that the video data corresponds to a 1280×1024 resolution. That is, 1280*1024 pixels are required to reproduce each frame associated with the film. However, if the monitor 56 supports a resolution 640×480, the scaling circuit 60 is capable of adjusting the video data so that the video data originally supporting the 1280×1024 resolution can be displayed on the monitor 56 supporting the resolution 640×480.

Then, the scaled image signals are passed to the video transmitter 62. The video transmitter 62 is capable of converting the images signals into driving signals suitable for the monitor 56. It is noteworthy that the monitor 56 can be a liquid crystal display (LCD) monitor embedded in the laptop computer or an external display device such as a TV, a cathode ray tube (CRT) monitor, or an external LCD monitor For example, if the monitor 56 is a liquid crystal display (LCD) monitor, the video transmitter 62 converts the image signals into driving signals compatible with the digital visual interface (DVI) specification. Similarly, if the monitor 56 is a TV, the video transmitter 62 is also capable of converting the image signals into S-video signals or RGB signals or YP_{b} Pᵣ signals used to drive the TV or HDTV. With regard to data stored on a DVD or a VCD, the data not only includes the video data, but also includes audio data. Therefore, the data outputted from the optical disk drive 52 are inputted into the audio decoder 64 for decoding the encoded audio data. Then, the reproduced audio signals are transmitted to the speaker 57 for driving the speaker 57.

Please note that the power block 66a is kept disabled. No operating voltage is inputted to the CPU 42, the north bridge circuit 44, the south bridge circuit 46, the memory 48, or the display controller 50. Therefore, the computer system 40 is not booted up through a prior art power-on-self-test (POST) procedure. That is, the south bridge circuit 46 does not process the data outputted from the optical disk drive 52. The overall power consumption of the computer system 40 is decreased because only the power block 66b is actuated to dissipate power.

Suppose that the laptop computer (computer system 40) is already booted up. Operation of the playback controller 54 is described as follows. One embodiment is that the south bridge circuit 46 processes the data outputted from the optical disk drive 52. Please note that both power blocks 66a, 66b are actuated after the computer system 40 is booted up. Therefore, the components within the power block 66a are workable. When the user inserts a DVD or a VCD containing video data associated with a film into the optical disk drive 52, the computer system 40 commands the optical disk drive 52 to transfer the video data to the south bridge circuit 46. Then, the south bridge circuit 46 further transfers the video data to the north bridge circuit 44. It is well-known that the video data is encoded according to a predetermined method such as an MPEG-2 algorithm. In addition, a prior art playback application executed by the CPU 42 is capable of decoding the encoded video data, and then the display controller 50 converts image signals corresponding to the decoded video data into driving signals. The driving signals are further transmitted to the playback controller 54. The video transmitter 62 in the playback controller 54 then processes the driving signals to successfully drive the monitor 56. Similarly, the audio data embedded in the video data are generated when the video data are simultaneously decoded by the same playback application, and the audio data are transferred to the audio processor 51. The audio processor 51 then converts the digital audio data into corresponding analog audio signals to drive the speaker 57. It is noteworthy that the playback controller 54 according to the present invention is capable of being compatible with the prior art playback scheme.

Another embodiment is that the data outputted from the optical disk drive 52 is directly passed to the playback controller 54 without being processed by the south bridge circuit 46. It is well-known that the encoded video data can be decoded by software or hardware. With regard to the computer system 40 shown in FIG. 2, the playback controller 54 functions as a hardware decoder for the video data. Similarly, the playback controller 54 is also capable of handling audio data accompanying the video data. In other words, the playback controller 54 takes place of the decoding functionality run by the playback application so as to reduce loading of the CPU 42. The playback application commands the optical disk drive 52 to transfer data retrieved from a DVD or a VCD to the playback controller 54 directly.

As mentioned above, the video decoder 58 and the audio decoder 64 are then used to respectively handle video data and-audio data. The scaling circuit 60 and the video transmitter 62 control images displayed on the monitor. The audio decoder 64 also converts digital audio data into analog audio signals to drive the speaker 57. The south bridge circuit 46 does not process the data outputted from the optical disk drive 52. Therefore, when the user uses the computer system 40 to play a film stored on the DVD or the VCD, loading of data transmission among components located within the power block 66a is greatly alleviated. That is, power dissipation of components within the power block 66a is accordingly reduced so that overall power consumption of the computer system 40 is lessened when the computer system 40 plays the film stored on the DVD or the VCD.

From the above description, when the computer system 40 is a laptop computer, the playback controller 54 can be utilized to reduce power consumption of the laptop computer for extending operational time of the battery device in the laptop computer no matter whether the computer system 40 is powered on or not. In addition, the playback controller 54 is capable of handing audio data disks such as a general audio compact disk (audio CD), a newly popularized SACD disk, or a newly popularized DVD-AUDIO disk. The related playback operation is identical to playback operation of the video data, and is briefly described as follows.

Suppose that the computer system 40 is a laptop computer, and is originally powered off. When the user presses one button such as a “PLAY” button or an “OPEN” button on housing of the optical disk drive 52, the power block 66b is activated. Please note that the power block 66a is kept disabled without starting a prior art booting operation such as a power-on-self-test (POST) procedure. The user, therefore, is capable of inserting one audio data disk (an audio CD for example) into the optical disk drive 52. The optical disk drive 52 retrieves audio data stored on the audio CD, and then transmits the audio data to the playback controller 54. The audio decoder 64 is activated to process the audio data, and converts the digital audio data into corresponding analog audio data. In the end, the audio decoder 64 drives the speaker 57 according to the analog audio data. In addition, the audio decoder 64 can also function as a digital equalizer used to adjust a frequency response corresponding to the analog audio data. Therefore, the sound quality outputted by the speaker 57 is improved.

Suppose that the computer system 40 is already booted up. Operating voltages are inputted into each component within the power blocks 66a, 66b. In other words, the audio data like the video data can be decoded either by hardware (the playback controller 54 for example) within the computer system 40 or software (a playback application for example) run by the CPU 42. Suppose the audio data are processed by the playback application. The computer system 40 blocks the video decoder 58 from decoding the audio data. Therefore, the audio data outputted from the optical disk drive 52 are passed to the south bridge circuit 46. The south bridge circuit 46 then transmits the received audio data to the north bridge circuit 44. Then, the CPU 42 is capable of accessing the audio data, and the executed playback application starts decoding the audio data. The decoded audio data are delivered to the audio processor 51. After the audio processor 51 converts the digital audio data into corresponding analog audio signals, the audio processor 51 drives the speaker 57 according to the analog audio signals. It is noteworthy that the playback controller 54 according to the present invention is capable of being compatible with the prior art playback scheme.

Suppose that the playback controller 54 is controlled to decode the audio data directly. Therefore, the computer system 40 blocks the south bridge circuit 46 from handling data transmission for the audio data. Therefore, the audio data outputted from the optical disk drive 52 are passed to the playback controller 54. Then, the audio decoder 64 starts decoding the decoded audio data, and converts the digital audio data into corresponding analog audio signals. In the end, the audio decoder 64 drives the speaker 57 according to the analog audio signals. The circuit components disposed within the power block 66a are not used to process the audio data outputted from the optical disk drive 52. Therefore, power consumption of the computer system 40 is then reduced.

The computer system 40 can be the laptop computer mentioned above or a desktop computer. With regard to the desktop computer, operation of the components disposed within the power block 66b is identical to above-described operation of the laptop computer. For example, the playback controller 54 is also compatible with the prior art playback scheme. In addition, the playback controller 54 can also directly process multimedia data outputted from the optical disk drive 52 without activating the south bridge circuit 46 to process the multimedia data so that power consumption of the desktop computer is accordingly reduced. When the desktop computer is powered off or is booted up, components disposed within the power block 66a are not used to process the multimedia data, and only components disposed within the power block 66b are activated to process the multimedia data. Therefore, power consumption of the desktop computer is reduced according to the present invention.

In the preferred embodiment, the user can selectively adopt the prior art playback scheme or the claimed playback scheme to play multimedia data. That is, the claimed playback controller 54 is capable of working according to the prior art playback scheme or the claimed playback scheme. Therefore, usage of the claimed playback controller 54 is flexible.

The speaker 57 can have a plurality of speaker units so as to generate a marvelous surrounding sound effect while the computer system 40 plays a film on the monitor 56. The playback controller 54 can be a single chip disposed on a motherboard or an expansion card connected to a slot or a connector electrically connected to the motherboard. For example, a system-on-a-chip (SOC) technology has been greatly developed. Therefore, the video decoder 58, the scaling circuit 60, the audio decoder 64, and the video transmitter 62 are be integrated into one chip with small size and low power consumption. The signal chip functions as a multimedia playback system used to handle video data stored on a video disk or audio data stored on an audio CD. If the playback controller 54 is disposed on the expansion card, the playback controller 54 is activated depending on whether an operating voltage is inputted into the playback controller 54 through the corresponding slot or connector. For example, the expansion card is compatible with a PCMCIA slot used by the laptop computer or a PCI slot used by the desktop computer. When the PCMCIA slot or the PCI slot is powered, the PCMCIA slot or the PCI slot then is capable of enabling the expansion card accommodating the playback controller 54.

It is noteworthy that video data and audio data can be stored on an optical disk drive or a magnetic disk. According to the above description, the computer system 40 utilizes the optical disk drive 52 to retrieve data stored on an optical disk. However, the computer system 40 is also capable of utilizing a magnetic disk drive (a hard-disk drive for example) to retrieve data stored on a magnetic disk. Based on the block diagram shown in FIG. 2, the optical disk drive 52 can be substituted by a magnetic disk drive. The magnetic disk drive, therefore, is located at the power block 66b. With regard to playback of the multimedia data, it is obvious that operation of the magnetic disk drive is identical to that of the optical disk drive 52. Therefore, the block diagram shown in FIG. 2 containing the optical disk drive 52 is used again for simplicity. Suppose that optical disk drive 52 is replaced by a well-known magnetic disk drive. When the computer system 40 is not booted up, the magnetic disk drive in the power block 66b is capable of transferring multimedia data stored on a magnetic disk to the playback controller 54 like the optical disk drive 52 does. Then, the playback controller 54 drives the monitor 56 to display images associated with the multimedia data. Similarly, when the computer system 40 is already booted up, the magnetic disk drive in the power block 66b is also capable of directly transferring multimedia data stored on a magnetic disk to the playback controller 54 without passing the multimedia data to the south bridge circuit 46 like the optical disk drive 52 does. Then, the playback controller 54 drives the monitor 56 to display images associated with the multimedia data. In other words, storage device such as the optical disk drive or the magnetic disk drive is disposed within the power block 66b. That is, any storage device used to retrieve the wanted multimedia data is disposed within the power block 66b. Therefore, provided that power block 66b is activated, the storage device in the power block 66b can successfully output wanted multimedia data to the playback controller 54, and then the playback controller 54 directly handles the received multimedia data. The principal objective of saving power is successfully achieved.

In contrast to the prior art computer system, the claimed computer system has a playback controller that can work even if the claimed computer system is not booted up. Therefore, if a user wants to play video data associated with a film, only the playback controller, the monitor, and the speaker are activated. In other words, the power consumption associated with playback of multimedia data is greatly reduced because only part of the components within the computer system dissipates power. In addition, because the user does not need to completely boot up the claimed computer system for playing multimedia data, it is convenient and simple for the user to operate the claimed computer system to play multimedia playback without waiting for the lengthy booting procedure. In addition, power consumption of the computer system is reduced without booting up the computer system. If the computer system is booted up, the playback controller can directly process multimedia data without help of the south bridge circuit, the central processing unit, and etc. Therefore, power consumption of the computer system is reduced as well.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for playing multimedia data on a computer system, the computer system comprising a central processing unit (CPU) used to control operations of the computer system, a storage device used to retrieve the multimedia data, a bridge circuit electrically connected between the CPU and the storage device for coordinating data transmission between the CPU and the storage device, and an output device, the method comprising:
(a) providing the computer system with a playback controller electrically connected to the storage device and the output device;
(b) controlling the storage device to transmit the multimedia data to the playback controller without activating the bridge circuit to process the multimedia data; and
(c) utilizing the playback controller to process the multimedia data, the playback controller driving the output device to play the multimedia data.

2. The method of claim 1 further comprising:
providing the playback controller and the output device with respective operating voltages and not providing the CPU and the bridge circuit with respective operating voltages.

3. The method of claim 1 wherein the storage device is an optical disk drive.

4. The method of claim 3 wherein the multimedia data is stored on an optical disk.

5. The method of claim 4 wherein the optical disk is a digital versatile disc (DVD).

6. The method of claim 4 wherein the optical disk is a video compact disk (VCD).

7. The method of claim 4 wherein the optical disk is an audio compact disk (audio CD).

8. The method of claim 1 wherein the storage device is a magnetic disk drive.

9. The method of claim 1 wherein the computer system is a portable computer or a desktop computer.

10. The method of claim 1 wherein the output device comprises at least a monitor.

11. The method of claim 10 wherein the playback controller comprises a video decoder, a scaling circuit, and a video transmitter, and the method further comprises a step (d) comprising:
using the video decoder to decode the multimedia data to generate corresponding video signals;
using the scaling circuit to convert the video signals corresponding to a first display resolution into scaled video signals corresponding to a second display resolution; and
using the video transmitter to transmit the scaled video signals to the monitor, wherein the monitor displays images associated with the multimedia data according to the second display resolution.

12. The method of claim 1 wherein the output device comprises at least a speaker.

13. The method of claim 12 wherein the playback controller comprises an audio decoder, and the method further comprises a step (d) comprising:
using the audio decoder to decode the multimedia data to generate corresponding audio signals, and using the audio decoder to output the audio signals to drive the speaker.

14. The method of claim 1 wherein the CPU, the playback controller, and the bridge circuit are disposed on a motherboard of the computer system.

15. The method of claim 1 wherein the CPU and the bridge circuit are disposed on a motherboard of the computer system, and the playback controller is disposed on an expansion card electrically connected to the motherboard.
